(19) United States
(12) Patent Application Publication
(10) Pub. No.: US 2025/0171166 A1
(43) Pub. Date: May 29, 2025

(54) IMPULSE PROPULSION SYSTEM

(71) Applicant: WARPA (WORLD ADVANCE RESEARCH PROJECT AGENCY), TOULOUSE (FR)

(72) Inventor: Jean-François GENESTE, TOULOUSE (FR)

(21) Appl. No.: 18/725,137

(22) PCT Filed: Dec. 27, 2022
(86) PCT No.: PCT/FR2022/052510

§ 371 Date: Jun. 28, 2024

(30) Foreign Application Priority Data
Dec. 28, 2021 (FR) FR2114570

(51) Int. Cl. B64G 1/40

(52) U.S. Cl. CPC B64G 1/409; B64G 1/411

(57) ABSTRACT

A propulsion system includes a motor having a pair of parallel longitudinal tubes. Each longitudinal tube includes a first end and a second end, and delimits an internal volume filled with a fluid. Each longitudinal tube includes a projectile, configured to move longitudinally in the internal volume, fixedly secured to a propeller. Each longitudinal tube includes a mechanism to launch the projectile in the internal volume, from the first end. The propeller being arranged so as to transform a translational movement of the projectile into a rotational movement. Each longitudinal tube includes a device to slow the rotation of the projectile in the internal volume, arranged at the second end, a device to return the projectile toward the first end, and a heat dissipation device. The propellers of the longitudinal tubes are contrarotating.

### TECHNICAL FIELD OF THE INVENTION

The invention relates to a propulsion system, and more specifically to an impulse propulsion system. In particular, the invention is intended for application in the space field, to equip a spacecraft such as a satellite.

### PRIOR ART

To date, space propulsion is based on the action and reaction principle. In a schematic manner, it its reflected, in terms of propulsion, by the conservation of momentum in an isolated system. Typically, if gases are ejected from a spacecraft with a given momentum, a momentum with the same modulus and an opposite direction to that of the gases is transmitted to said spacecraft. In such a case, it is necessary to consume material to advance, since a momentum should be ejected out of the spacecraft. The efficiency of a propulsion system is measured by a quantity called specific impulse, whose unit is the second. However, this quantity does not represent everything. Indeed, currently, to place a six-tonne telecommunications satellite from a geostationary transfer orbit (also so-called “GTO” orbit) into a geostationary orbit (also so-called “GEO” orbit), with a chemical propulsion wherein the specific impulse of the motor lasts 320 seconds, eight days are necessary and three tonnes of fuel are on-board said satellite. With an electric propulsion wherein the specific impulse of the motor is 1,500 seconds, eight months are necessary but only 400 kg of fuel (generally xenon) are on-board, bringing the mass of the satellite to less than four tonnes.

In other words, current electric propulsion systems have a high specific impulse, but a low thrust, which results in very long mission's times and lower launch costs, because the mass of the fuel, for a given mission, is much lower than with chemical propulsion systems.

Moreover, once a satellite, whatever it is, is in position, its orbit describes a plane. A plane change cannot currently be considered because of the excessive fuel consumption.

On the other hand, a satellite in a polar orbit, therefore travelling, generally has a service life of five years, which service life corresponds to the time necessary to consume the on-board fuel.

Finally, space debris becoming more numerous, the number of avoidance manoeuvres increases and, consequently, the service life of the satellites in low orbit potentially decreases.

### DISCLOSURE OF THE INVENTION

The present invention aims to overcome the aforementioned drawbacks.

To this end, the present invention provides a propulsion system comprising a motor comprising a pair of parallel longitudinal tubes, each longitudinal tube comprising a first end and a second end, and defining an internal volume filled with a fluid. Each longitudinal tube comprises:
a projectile, configured to move longitudinally in the internal volume, and fixedly secured to a propeller,
a mechanism for launching the projectile in the internal volume, from the first end of said longitudinal tube, the propeller being arranged so as to transform a translational movement of the projectile into a rotational movement,
a device for braking the rotation of the projectile in the internal volume, positioned at the second end of the longitudinal tube,
a device for returning the projectile from the second end towards the first end of the longitudinal tube,
a heat dissipation device.

Said mechanism for launching the projectile and said device for returning the projectile being powered by at least one power source.

Each longitudinal tube comprises, in its internal volume, a projectile and a propeller fixedly secured to the projectile.

By “fixedly secured”, it should be understood that there is no degree of freedom between the projectile and the propeller.

Said propellers of the projectiles located in the two longitudinal tubes are contrarotating. Thus, when the propellers will rotate, two identical, but opposite, kinetic moments will be created and will substantially cancel out.

Such a propulsion system is an impulse thrust propulsion system. At each launch of the projectile in its longitudinal tube by the launching mechanism, a momentum towards the second end of the longitudinal tube is imparted on the projectile. During the impulse, a momentum in the opposite direction is imparted on the longitudinal tubes, and therefore on the propulsion system, in accordance with the above-described action and reaction principle.

Advantageously, the propulsion system according to the invention allows converting the translational movement of the projectile in part into a rotational movement, thanks to the viscosity of the fluid. A portion of the rotational movement will be transformed into heat, due to the viscosity of the fluid, and another portion will be transformed, depending on the nature of the braking device, either into heat, or into electrical energy. Thus, the portion transformed into rotation does not intervene in the equilibrium of the total longitudinal momentum of the system.

At a given time point, the projectile has a non-zero translational speed towards the second end. Hence, it will encounter fluid molecules and the propeller will transform a portion of the translational energy into rotational energy of the projectile. At the end of travel, at the second end of the longitudinal tube, the projectile potentially no longer has any translational speed, but has a rotational speed. If we apply the principle of conservation of momentum, the kinetic moment should also be conserved. Yet, it is the fluid contained in the internal volume of the longitudinal tube, and not the longitudinal tube itself, which sets the propeller and the projectile into motion. Hence, we would have a system with a conservation of translational momentum, i.e. non-movable, but with a non-zero angular moment. Hence, the principle of conservation of momentum in an isolated system does not apply in our case, since the system is not isolated.

In addition, in each longitudinal tube, the heat created during the travel of the projectile in the internal volume is evacuated by means of the heat dissipation device. Hence, the use of a heat dissipation device proves that the propulsion system does not function like an isolated system.

The longitudinal tubes (volume, length), the mass of the projectile and the impulse imparted on the projectile are sized so that, in each longitudinal tube, the translational movement of the projectile stops at the second end of the longitudinal tube.

Advantageously, the device for returning the projectile allows returning the projectile from the second end towards the first end of the longitudinal tube in order to be launched again.

Advantageously, the propulsion system according to the invention is a propulsion system with a completely passive and dissipative reaction mass, wherein each projectile and its propeller serve as a reaction mass, and are configured to move freely and passively in the internal volume of the longitudinal tube in which they are arranged. The propeller is arranged so as to transform a translational movement of the projectile into a rotational movement, via a passive and dissipative interaction with the fluid contained in the internal volume of the longitudinal tube containing said propeller.

In particular embodiments, the invention further meets the following characteristics, implemented separately or in each of the technically operative combinations thereof.

In particular embodiments of the invention, to avoid contact between the projectile and the longitudinal tube, each longitudinal tube comprises a device for holding the projectile in the internal volume.

In particular embodiments of the invention, the device for holding the projectile comprises at least one connecting arm extending between the projectile and the longitudinal tube.

In particular embodiments of the invention, in order not to hinder the rotation of the projectile during travel thereof in the longitudinal tube, the holding device and the projectile are connected by a pivot connection.

In particular embodiments of the invention, to direct the projectile, each longitudinal tube comprises a device for guiding the projectile in translation in the internal volume.

In particular embodiments of the invention, the device for guiding the projectile in translation cooperates with the device for holding the projectile.

In particular embodiments of the invention, the same power source is configured to power said mechanism for launching the projectile and said device for returning the projectile of at least one longitudinal tube.

In particular embodiments of the invention, the propulsion system comprises a tilting device configured to independently pivot each of the two longitudinal tubes about a parallel respective pivot axis, preferably by about 90°, in opposite directions. This tilting device is activated only once the projectile has reached the second end of the longitudinal tube, to accelerate the return of the projectile, by the device for returning the projectile, towards the first end of the longitudinal tube.

In particular configurations, to increase the thrust of the propulsion system in the same direction, said propulsion system comprises a plurality of pairs of parallel longitudinal tubes, the pairs being arranged parallel to one another.

The invention also relates to a vehicle, in particular a spacecraft, comprising a propulsion system in accordance with at least one of its embodiments. A spacecraft equipped with such a propulsion system would have its travel time reduced for a given orbit, in comparison with a spacecraft equipped with conventional chemical or electrical propulsion systems, with no fuel consumption.

### BRIEF DESCRIPTION OF THE FIGURES

The invention will be better understood upon reading the following description, given merely as non-limiting example, and made with reference to the figures:

FIG. 1 illustrates a propulsion system comprising a motor comprising a pair of longitudinal tubes, according to an embodiment of the invention, and

FIG. 2 illustrates a variant embodiment of a projectile in a longitudinal tube.

In these figures, for clarity, the drawings are not plotted to scale, unless stated otherwise.

### DESCRIPTION OF THE EMBODIMENTS

The present invention relates to a propulsion system.

In general, this propulsion system could equip any transport means, in particular those of the aeronautical, space, railway, automotive or maritime fields, without this restricting the invention.

The invention is described in the particular context of one of its preferred fields of application in which the propulsion system is intended to be installed in a spacecraft, such as a satellite. However, nothing excludes the possibility of arranging the propulsion system in any other vehicle type.

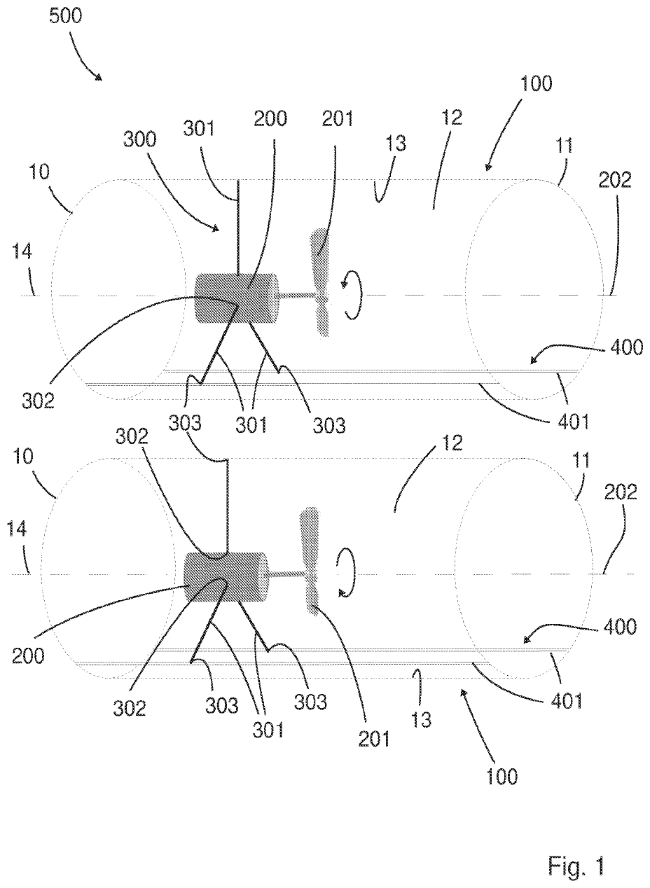

FIG. 1 schematically illustrates a propulsion system according to a preferred embodiment of the invention.

The propulsion system comprises a motor 500. Said motor comprises at least one pair of longitudinal tubes 100.

In the remainder of the description, the propulsion system will be described in the preferred case where the motor comprises a pair of longitudinal tubes, as illustrated in FIG. 1.

Advantageously, the two longitudinal tubes 100 are arranged parallel to one another.

Preferably, the two longitudinal tubes 100 are similar and independent of one another.

Each longitudinal tube 100 comprises two longitudinal ends, so-called first end 10 and second end 11. Each longitudinal tube 100 is hermetically closed, sealed and closed at both longitudinal ends thereof.

Advantageously, the two longitudinal tubes 100 are positioned in the same direction, with their first ends 11 arranged on the same side.

In the example of FIG. 1, the first ends 11 of the longitudinal tubes 100 are located to the left in FIG. 1.

Preferably, each longitudinal tube 100 has a circular cross-section, as illustrated in FIG. 1, but may also have any other cross-sectional shape, for example square, rectangular, elliptical, etc., without this limiting the invention.

Preferably, each longitudinal tube 100 is made of a carbon material.

Each longitudinal tube 100 delimits a hollow internal volume 12 in which a fluid evolves.

Preferably, the fluid is a viscous fluid.

In a preferred embodiment, the fluid is a gas, such as air.

In other embodiments, the fluid may be a Newtonian fluid or a non-Newtonian fluid. It should be recalled that a fluid is so-called Newtonian when it does not modify its behaviour under the effect of mechanical stresses.

In other embodiments, the fluid may be a fluid whose viscosity changes under the action of a magnetic or electrical field. These fluids are so-called magnetorheological fluid or electrorheological fluid respectively.

Each longitudinal tube 100 comprises a projectile 200 in its internal volume 12. Said projectile is intended and configured to move longitudinally in the longitudinal tube 100.

Preferably, the projectiles 200 of each longitudinal tube 100 are identical.

In a first variant, as illustrated in FIG. 1, each projectile 200 may for example be in the form of a closed, hollow or solid cylinder. For example, each projectile 200 may have a circular, square, rectangular, elliptical, etc., cross-section, without this limiting the invention. The projectile has a length much smaller than the length of the longitudinal tube.

In one embodiment, as illustrated in FIG. 1, the longitudinal tube 100 and its projectile 200 have the same cross-section.

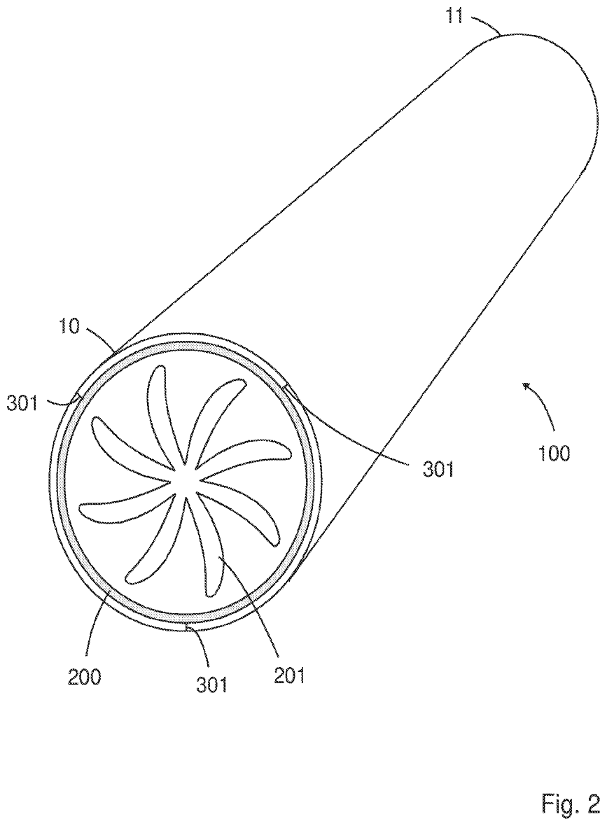

In a second variant of the projectile, as illustrated in FIG. 2, when the longitudinal tubes 100 have a circular cross-section, each projectile 200 may be in the form of an annular, hollow cylinder open at its ends, the wall of which is located proximate to an inner face 13 of the longitudinal tube 100. Thus, the mass of the projectile 100 is distributed close to the periphery of the longitudinal tube 100.

Advantageously, each projectile 200 is fixedly secured to a propeller 201.

By fixedly secured, it should be understood that there is no degree of freedom between the projectile 200 and the propeller 201. In other words, when the propeller 201 rotates, it drives the projectile in rotation. When it rotates on itself, the propeller 201 drives the projectile in rotation on itself.

It should be understood that a projectile 200 and its propeller 201 are both arranged in the internal volume 12 of a longitudinal tube. Hence, there are as many propellers as projectiles, and as longitudinal tubes.

Each projectile 200 and its propeller 201 are arranged in a longitudinal tube 100 such that an axis of rotation 202 of the propeller, and consequently an axis of rotation of the projectile, is parallel to or coincident with an axis of revolution 14 of said longitudinal tube 100. Preferably, the axis of rotation 202 of the propeller 201 is coincident with the axis of revolution 14 of said longitudinal tube 100, as illustrated in FIG. 1.

In one embodiment, for projectiles according to the first variant, as illustrated in FIG. 1, the propellers 201 of the projectiles 200 are located at one end of the projectile, on the same side, in their respective longitudinal tubes 100.

Preferably, as illustrated in FIG. 1, in each longitudinal tube 100, the projectile 200 faces the first end 10 of said longitudinal tube 100 and the propeller 201 faces the second end 11 of said longitudinal tube 100.

In another embodiment, for projectiles according to the second variant, as illustrated in FIG. 2, the propellers 201 of the projectiles are located inside the cylinder forming the projectiles, in their respective longitudinal tubes 100. Thus, the projectiles 100 disturb the flow less.

Advantageously, the propellers 201 of the projectiles 200 located in the longitudinal tubes 100 of the pair of longitudinal tubes are contrarotating, i.e. they rotate in opposite directions. Thus, when the propellers 201 rotate, two identical, but opposite, kinetic moments will be created simultaneously, the sum of which is approximately zero. Thus, a spacecraft that would be equipped with a propulsion system with an even number of longitudinal tubes 100 and the arrangement of the propellers as described will not be unbalanced during the thrust.

The efficiency of the propeller 201, i.e. its ability to transform the translational movement of the projectile 200 into a rotational movement, depends in particular on the fluid contained in the longitudinal tube and on the pressure in the internal volume of said longitudinal tube.

In non-limiting embodiments of the invention, a propeller 201 may be a propeller such as the aircraft propeller type, of the low-pressure compressor propeller type of aircraft turbojet engines, of the centrifugal compressor propeller type.

In an improved embodiment, the propeller is a variable-pitch propeller. Preferably, an electronic, or mechanical, device is configured to adjust the pitch, in particular by modifying the pitch angle of the blades of the propeller.

Preferably, each longitudinal tube 100 comprises a device 300 for holding the projectile in the internal volume 12 of said longitudinal tube. Advantageously, such a holding device 300 allows preserving the positioning of the projectile 200 at a distance from the inner face 13 of the longitudinal tube 100, so that the projectile 200, and/or its propeller 201, touches said inner face during the operation of the motor.

Preferably, the projectile holding device 300 is identical for both tubes of the pair of longitudinal tubes 100.

In an embodiment of a holding device 300, said holding device comprises at least one connecting arm 301, preferably a plurality of connecting arms 301. Each connecting arm 301 is rigid and extends between the projectile 200 and the longitudinal tube 100. Each connecting arm 301 comprises a first end 302 arranged on the projectile 200 side and a second end 303 arranged on the longitudinal tube 100 side.

Preferably, in the case where the holding device 300 comprises a plurality of connecting arms 301, these are arranged in the same plane.

In the non-limiting embodiment described in FIG. 1, the holding device 300 comprises three connecting arms 301 arranged at 120° with respect to one another. Such number and arrangement of the connecting arms is particularly suitable when the longitudinal tube has a circular cross-section, for example.

In another embodiment, not shown in the figures, the holding device comprises four connecting arms arranged at 90° with respect to one another. Such number and arrangement of the connecting arms is particularly suitable when the longitudinal tube has a square or rectangular cross-section, for example.

Preferably, the holding device 300 is connected to the projectile 200 such that it does not prevent the rotation of the projectile 200 about its axis of rotation. In other words, the holding device and the projectile are connected by a connection with one single degree of freedom. This single degree of freedom is a rotational degree of freedom, enabling the rotation of the projectile about its axis of rotation. The connection is a pivot connection.

In one embodiment, the holding device is connected to the projectile via at least one bearing (not shown).

In one embodiment, in the case where the holding device 300 comprises a plurality of connecting arms 301 arranged in the same plane, each first end 302 of a connecting arm is connected to the projectile 200 via one single bearing.

Preferably, each longitudinal tube 100 comprises a device for guiding the projectile in translation 400. Advantageously, such a translational guide device 400 allows guaranteeing the movement of the projectile 200 longitudinally in the longitudinal tube 100 between the two longitudinal ends 10, 11. Advantageously, said translational guide device 400 cooperates with the projectile holding device 300.

Preferably, the translational guide device 400 is identical for both tubes of the pair of longitudinal tubes 100.

In an embodiment of a translational guide device 400, as illustrated in the figure, the translational guide device 400 comprises at least one longitudinal groove 401, formed in the longitudinal tube 100, from the inner face 13.

Preferably, the longitudinal tube 100 comprises as many longitudinal grooves 401 as connecting arms 301. The second end 303 of each connecting arm 301 is configured to slip, slide or roll in an associated longitudinal groove 401.

Each longitudinal tube 100 comprises a mechanism for launching the projectile (not shown in the figure). Said mechanism for launching the projectile is configured to exert a thrust on the projectile 200 so as to set it in motion and to launch it in the longitudinal tube 100.

Preferably, the mechanism for launching the projectile is arranged at the first end 10 of the longitudinal tube 100. Thus, the projectile 200 moves in the longitudinal tube 100 from the first end 10 towards the second end 20.

Preferably, the mechanism for launching the projectile is identical for both tubes of the pair of longitudinal tubes 100.

In one embodiment, the mechanism for launching the projectile may comprise an electromagnet.

In another embodiment, the mechanism for launching the projectile may comprise a catapult or compression spring type mechanical system.

In the embodiment where the mechanism for launching the projectile is a compression spring, the projectile is launched in the longitudinal tube by the expansion of said compression spring which has been compressed beforehand.

Preferably, at least one electric power source (not shown in the figure) is configured to activate the mechanism for launching the projectile in each longitudinal tube 100. Advantageously, said at least one power source is connected to the solar panels installed on the spacecraft or the batteries on-board said spacecraft.

Thus, at each longitudinal tube 100, the mechanism for launching the projectile is advantageously configured to impart a starting impulse on the projectile 100, at a predetermined speed. A momentum, or a kinetic energy, towards the second end 11 of the longitudinal tube 100 is then imparted on said projectile. At the time of this impulse, an equal momentum, in the opposite direction, is imparted on the longitudinal tube 100. During the advance of the projectile 200 in the longitudinal tube 100, the blades of the propeller 201 will undergo a drag, which will brake the projectile 200, and a lift which will drive the propeller 201 and therefore the projectile 200, in rotation. Thanks to the propeller 201, the translational movement of the projectile 200 in a longitudinal tube 100 will thus be progressively transformed into a rotational movement. This rotational movement of the projectile 200 will cause a progressive braking of the translational movement of the projectile 200 in the longitudinal tube 100, while creating heat.

Each blade of the propeller 201 will have a shape drag and a friction drag. The friction drag, related to the viscosity of the fluid, will enable movement according to the well-known laws of fluid mechanics. In a particular embodiment, the blades of the propeller will be designed so as to maximise the friction drag. It is this friction which will generate heat, and, this heat being released to the outside, makes the system non-isolated, thereby a non-conservation of the overall momentum.

In the embodiment where the propeller is a variable-pitch propeller, the associated electronic or mechanical device is configured to adjust the pitch during the movement of the projectile in its longitudinal tube, allowing maximising frictions.

In other words, at each longitudinal tube 100, the initial translational kinetic energy of the projectile 200 is partially transformed, on the one hand, into rotational kinetic energy and, on the other hand, into heat. It is this rotational kinetic energy portion, created “naturally”, which will be obtained, essentially, as an equivalent of the momentum transmitted to the spacecraft at the end of the process of movement of the projectile in the tube longitudinal.

The longitudinal tubes 100 are sized in length so that the translational movement of the projectile 200 stops proximate to the second end 11 of the longitudinal tube 100, the closest to said second end, without the projectile 200 or the propeller 201 of the projectile 200 touching said second end 11.

In particular, the length of a longitudinal tube 100 depends on the mass of the projectile, on the impulse imparted on the projectile 200 by the mechanism for launching the projectile, on the efficiency of the propeller, in the fluid environment in which the projectile is moving, and on the viscosity of the fluid, which viscosity may depend on parameters such as the temperature or also on externally regulated parameters like an electromagnetic, electrical or magnetic field depending on the very nature of the fluid. The calculation of this length is within the reach of a person skilled in the art.

In one embodiment, each longitudinal tube may have a length in the range of 4 m and a diameter in the range of 50 cm, with a projectile mass in the range of one kilogram. The launch speed of the projectile is in the range of 400 to 500 km/h.

As described before, for each longitudinal tube 100, following the impulse imparted on the projectile 200, heat is created in said longitudinal tube during the movement of the projectile, because of the frictions of the fluid.

Advantageously, each longitudinal tube 100 comprises a heat dissipation device (not shown in the figure).

Preferably, the heat dissipation device is identical for both tubes of the pair of longitudinal tubes 100.

In one embodiment, the heat dissipation device is a fin-type radiator.

In the preferred application where the propulsion system equips a spacecraft, for each longitudinal tube 100, the associated heat dissipation device can exchange with the empty space only via a black body radiation. Hence, the heat dissipation device is advantageously configured to emit photons, these photons having a momentum.

Advantageously, the heat dissipation device of each longitudinal tube 100 is arranged so that the emission of the photons takes place in a direction promoting the increase in the momentum of the propulsion system, therefore of the spacecraft.

Advantageously, this emission of photons guarantees that the propulsion system cannot therefore be considered as an isolated system.

As described before, for each longitudinal tube 100, after launching the projectile 200, the translational travel of the projectile 200 stops at the second end 11 of the longitudinal tube 100. At of this second end 11, the projectile 200 is only rotating and rotates on itself at a given speed.

Advantageously, each longitudinal tube 100 comprises a device for braking the rotation of the projectile (not shown in the figure).

Preferably, the braking device is identical for both tubes of the pair of longitudinal tubes 100.

In some embodiments, the braking device comprises an electromagnetic brake or a mechanical brake.

Braking the rotation of the projectile in each longitudinal tube will create an opposite rotational parasitic kinetic momentum. Yet, the motor of the propulsion system comprising a pair of longitudinal tubes, inside which the projectiles with their propellers rotate in a contrarotating manner, braking, as a first approximation, will not have a consequence at the propulsion system and therefore at the spacecraft, because the rotational kinetic moments will substantially cancel out.

As described before, for each longitudinal tube 100, after launching the projectile 200, the translational travel of the projectile 200 stops at the second end 11 of the longitudinal tube 100 and then the rotation of the projectile 200 is braked.

Advantageously, each longitudinal tube 100 comprises a device for returning the projectile (not shown in FIG. 1) towards the first end 10 of said longitudinal tube 100.

Preferably, the device for returning the projectile is identical for the two tubes of the pair of longitudinal tubes 100.

This device for returning the projectile is configured to return the projectile 200 located at the second end 11 back to the first end 10 of the longitudinal tube 100 in order to be launched again, where necessary, via the mechanism for launching the projectile.

Preferably, the device for returning the projectile is configured to return the projectile 200 to a constant speed, lower than the launch speed of the projectile in the transverse tube. Advantageously, the return of the projectile 200 towards the first end 10 at a constant speed allows creating practically no parasitic momentum at the propulsion system, and therefore at the spacecraft.

In some embodiments, the device for returning the projectile may comprise an electromagnet or a worm screw device.

In one variant, to accelerate the return of the projectile 200 towards the first end 10 of the longitudinal tube 100, the propulsion system may comprise a tilting device (not shown in FIG. 1). Such a tilting device is configured to make each of the two longitudinal tubes 100 pivot independently about a parallel respective pivot axis, by an angle in the range of 90°, but in the opposite direction. Afterwards, the projectiles 200 of each longitudinal tube 100 are returned towards the first end 10 of the associated longitudinal tube 100, therefore in the opposite direction, with the associated return device described hereinabove. The return of each projectile 200 towards the first end 10 of the associated longitudinal tube 100 could be carried out more rapidly because, on the one hand, the created momentums cancel out and, on the other hand, the created momentums do not parasitise the momentum imparted on the projectile in the axis of revolution of the longitudinal tube during the impulse, and therefore the opposite momentum transmitted to the longitudinal tube, during the impulse, and consequently to the propulsion system.

Preferably, at least one electric power source (not shown in the figure), configured to activate the device for returning the projectile in each longitudinal tube.

Said at least one electric power source is connected to the solar panels installed on the spacecraft or the batteries on-board said spacecraft.

In one embodiment, a common electric power source is configured to activate the mechanism for launching the projectile and to activate the device for returning the projectile of a longitudinal tube.

Hence, the propulsion system according to the invention as described is an impulsed thrust propulsion system rather than a continuous thrust propulsion system.

At each launch of the projectiles 200 in the two longitudinal tubes 100, a momentum, equal, yet opposite, to the momentum imparted on the projectile, is imparted on the longitudinal tubes, and therefore on the propulsion system.

Preferably, to avoid an imbalance of the spacecraft, the launches of the projectiles 200 in the two longitudinal tubes 100 are carried out in a synchronised manner.

Depending on the frequency of the impulses, i.e. depending on the launch frequency of the projectiles 200 in each longitudinal tube 100, will depend on the average thrust per unit time of the propulsion system.

In particular, the frequency of the impulses depends on the time spent by the projectile 200 in each longitudinal tube 100 to return, with the return device, from the second end 11 of the longitudinal tube 100 to the first end 10, the selected type of return device to return the projectile 200.

The thrust of the propulsion system, in the same direction, could also be increased by increasing the number of pairs of longitudinal tubes 100, each pair of longitudinal tubes being arranged parallel to one another, with all longitudinal tubes in the same direction.

In particular embodiments, not shown in the figure, to improve in particular the efficiency of the propellers 201, each longitudinal tube 100 may comprise a device for modifying the fluid viscosity and/or a device for modifying the temperature of the fluid and/or a device for modifying the pressure of the fluid.

In one embodiment, to produce thrusts in all directions, the at least one pair of longitudinal tubes is mounted on a multi-axis system configured to orient said at least one pair of longitudinal tubes in one direction, opposite to the desired thrust direction.

In some embodiments, the devices for braking the rotation of the projectile 200 in the longitudinal tubes creating parasitic kinetic moments, the spacecraft comprising the propulsion system may comprise inertia wheels configured to create an on-board kinetic momentum intended to balance the spacecraft.

In a propulsion system comprising a given number of pairs of longitudinal tubes arranged parallel to one another, the propulsion system could therefore be configured in two ways:
a) either all projectiles 200 of all pairs of longitudinal tubes 100 are launched in a synchronised manner: in this case, the thrust will be increased. In particular, the frequency of the impulses depends on the time spent by the projectile in each longitudinal tube to move from the first end to the second end of the longitudinal tube, and to return, with the return device, from the second end to the first end of the longitudinal tube,
b) or the projectiles 200 of each pair of longitudinal tubes 100 are launched successively: in this case, the thrust will be lower than if all projectiles of all pairs of longitudinal tubes are launched in a synchronised manner, but the frequency of the impulses will be increased.

The selected configuration may depend on the vehicle in which the propulsion system will be used, and in particular on the manoeuvres carried out by the vehicle.

In the case of the use of the propulsion system in a preferred application in the space field, the spacecraft equipped with such a propulsion system can use the high thrust configuration (configuration a)) for some manoeuvres, such as for example the orbit circularisation manoeuvre, and the lower, yet more frequent, thrust configuration (configuration b)), for other manoeuvres, such as, for example, manoeuvres in “disturbed” environments (planets with an atmosphere for promoting aerocapture, gravitational acceleration in proximity of dissymmetrical planets, etc.).

1. A propulsion system comprising a motor comprising a pair of parallel longitudinal tubes, each longitudinal tube comprising a first end and a second end, and defining an internal volume filled with a fluid, said each longitudinal tube comprising:
a projectile, configured to move longitudinally in the internal volume, and fixedly secured to a propeller, with no degree of freedom between the projectile and the propeller;
a launcher configured to launch the projectile in the internal volume, from the first end of said each longitudinal tube, the propeller being arranged so as to transform a translational movement of the projectile into a rotational movement;
a brake to slow and stop a rotation of the projectile in the internal volume, positioned at the second end of said each longitudinal tube;
a returner to return the projectile from the second end towards the first end of said each longitudinal tube;
a heat dissipation device;
said launcher and said returner being powered by at least one power source; and
propellers located in the pair of parallel longitudinal tubes being contrarotating.

2. The propulsion system according to claim 1, wherein said each longitudinal tube comprises a holder to hold the projectile in the internal volume.

3. The propulsion system of claim 2 wherein the holder comprises at least one connecting arm extending between the projectile and said each longitudinal tube.

4. The propulsion system according to claim 2, wherein the holder and the projectile are connected by a pivot connection.

5. The propulsion system according to claim 1, wherein said each longitudinal tube comprises a guide to guide the projectile in translation in the internal volume.

6. The propulsion system according to claim 5, wherein said each longitudinal tube comprises a holder to hold the projectile in the internal volume; and wherein the guide cooperates with the holder.

7. The propulsion system according to claim 1, wherein a same power source is configured to power said launcher and said returner of at least one longitudinal tube.

8. The propulsion system according to claim 1, comprising a tilter configured to independently pivot each of two pair of parallel longitudinal tubes about a respective parallel pivot axis.

9. The propulsion system according to claim 1, further comprising a plurality of pairs of parallel longitudinal tubes arranged parallel to one another.

10. A spacecraft comprising a propulsion system according to claim 1.

11. The propulsion system according to claim 1, wherein the brake is an electromagnetic brake.

12. The propulsion system according to claim 1, wherein the brake is a mechanical brake.

13. The propulsion system according to claim 1, wherein the returner is a worm screw.
